(19) United States
(12) Patent Application Publication
(10) Pub. No.: US 2021/0149009 A1
(43) Pub. Date: May 20, 2021

(54) METHODS TO SUPPORT LTE OTDOA FOR NR DEVICES

(71) Applicant: TELEFONAKTIEBOLAGET LM ERICSSON (PUBL), Stockholm (SE)

(72) Inventors: Sara Modarres Razavi, LINKÖPING (SE); Fredrik Gunnarsson, LINKÖPING (SE); Ritesh Shreevastav, UPPLANDS VÄSBY (SE)

(73) Assignee: TELEFONAKTIEBOLAGET LM ERICSSON (PUBL), Stockholm (SE)

(21) Appl. No.: 17/045,135

(22) PCT Filed: Apr. 5, 2019
(86) PCT No.: PCT/IB2019/052834

§ 371 Date: Oct. 2, 2020

Related U.S. Application Data
(60) Provisional application No. 62/653,126, filed on Apr. 5, 2018.

(51) Int. Cl. G01S 5/00; G01S 5/02; G01S 5/10; H04W 64/00

(52) U.S. Cl. CPC G01S 5/0036; H04W 64/003; G01S 5/10; G01S 5/0236

(57) ABSTRACT

A method in a wireless device served by a New Radio (NR) network node, in a NR cell, is provided. The method comprises: sending, to a network node, a positioning request for performing measurements based on Observed Time Difference of Arrival (OTDOA); in response to the request, receiving OTDOA assistance information based on timing information of the NR cell; and performing OTDOA measurements on reference signals based on the received OTDOA assistance information.

### RELATED APPLICATIONS

The present application claims the benefits of priority of U.S. Provisional Patent Application No. 62/653,126, entitled “Methods to support LTE OTDOA for NR devices”, and filed at the United States Patent and Trademark Office on Apr. 5, 2018, the content of which is incorporated herein by reference.

### TECHNICAL FIELD

The present description generally relates to wireless communications and in particular to performing positioning measurements in the wireless communications.

### BACKGROUND

Positioning has been a topic in Long Term Evolution (LTE) standardization since Third Generation Partnership Project (3GPP) Release 9. The primary objective is to fulfill regulatory requirements for emergency call positioning.

In the legacy LTE standards, in outdoor positioning, the following techniques are supported:
Enhanced Cell IDentity (E-CID): Essentially cell ID information is used to associate the device to the serving area of a serving cell, and then additional information is used to determine a finer granularity position.
Assisted Global Navigation Satellite System (GNSS): The GNSS information is retrieved by the device, but the location server (Evolved Serving Mobile Location Center (E-SMLC)) may provide assistance information to the device for determining the location/position of the device. For example, the device may not be able to determine the location/position itself so it provides its calculation to the E-SMLC; the E-SMLC then estimates the User Equipment (UE) position and provides it to the UE.
OTDOA (Observed Time Difference of Arrival): The device estimates the time difference of reference signals from different base stations and sends the estimated time difference to the E-SMLC for multi-lateration.
UTDOA (Uplink TDOA): The device is requested to transmit a specific waveform that is detected by multiple location measurement units (e.g. an eNB) at known positions. These measurements are forwarded to the E-SMLC for multi-lateration.

Positioning in New Radio (NR) is proposed to be supported by the architecture shown in FIG. 1. Location Management Function (LMF) is the location server in NR. There are also interactions between the location server and the gNodeB (gNB) via the New Radio Positioning Protocol A (NRPPa) protocol. The interactions between the gNodeB and the device (e.g. UE) is supported via the Radio Resource Control (RRC) protocol. In Release 15 NR, it is planned to have positioning support to fulfill the emergency call scenario for Release 15 NR devices as well. Currently, there have been some agreements in the NR WI (Work Item) in terms of positioning support. Here is a list of some of those agreements:
The full scope of LTE Positioning Protocol (LPP) shall be supported by NR System Architecture and NR devices;
LPP messages are transported in Non-Access Stratum (NAS) messages within NR RRC (similar to LTE RRC);
Support of UTDOA method in NR may be revisited in further releases after further progress in SA2 (System Aspect 2) work;
Positioning network elements (UE, NG-RAN, Access and Mobility Management Function (AMF), LMF) in the positioning related architecture in TS 23.501 should be used as the basis for positioning support for New Generation Radio Access Network (NG-RAN) in Release 15;
It is up to the LMF and E-SMLC implementation to handle the information sharing between Evolved UMTS Terrestrial Radio Access Network (E-UTRAN) cells and LMF.

### SUMMARY

According to the current agreement, an NR device that has LTE OTDOA capability should be able to use (or support) this positioning method from an E-UTRA network. However, there exists a systematic issue with this support (or with such a scenario), and that is because the reference cell and the list of neighbor cells assistance data information provided by the location server to the device are based on the System Frame Number (SFN) of the serving cell (SFN0). However, the NR device is connected to the NR cell and hence the potential LTE serving cell of the device is unknown to both the location server and the device. The OTDOA procedure will basically fail when performed by the NR device, unless this problem is solved.

Some embodiments provide a solution to solve this problem by using the serving NR cell as the time reference. Recently, there has been a new RRC measurement called SFTD (Subframe and Frame boundary Time Difference) supported for LTE devices. LTE devices with supporting capability can measure and report SFTD to NR neighbour cells via LTE RRC. For example, the embodiments may exploit the SFTD measurements available (in LTE) to be reported to the location server where a database of timing difference information between LTE and NR cells can be stored. The database can significantly reduce the number of signaling steps required to perform OTDOA positioning for NR devices.

According to a first aspect, some embodiments include a method performed by a wireless device for performing positioning measurements. The method generally comprises: sending, to a network node, a positioning request for performing measurements based on Observed Time Difference of Arrival (OTDOA); in response to the request, receiving OTDOA assistance information based on timing information of the NR cell; and performing OTDOA measurements on reference signals based on the OTDOA assistance information.

According to a second aspect, some embodiments include a method in a wireless device served by a New Radio (NR) cell, for performing positioning measurement. The method comprises: sending, to a network node, a positioning request for performing measurements based on Observed Time Difference of Arrival (OTDOA); in response to sending the positioning request, receiving from the network node a request to determine timing information of a cell in a Long Term Evolution (LTE) network; sending determined timing information to the network node; receiving OTDOA assistance information based on the timing information of the cell in the LTE network; and performing OTDOA measurements on reference signals based on the OTDOA assistance information.

According to a third aspect, some embodiments include a wireless device configured, or operable, to perform one or more functionalities (e.g. actions, operations, steps, etc.) as described herein.

In some embodiments, the wireless device may comprise one or more communication interfaces configured to communicate with one or more other radio nodes and/or with one or more network nodes, and processing circuitry operatively connected to the communication interface, the processing circuitry being configured to perform one or more functionalities of the wireless device as described herein. In some embodiments, the processing circuitry may comprise at least one processor and at least one memory storing instructions which, upon being executed by the processor, configure the at least one processor to perform one or more functionalities of the wireless device as described herein.

In some embodiments, the wireless device may comprise one or more functional modules configured to perform one or more functionalities of the wireless device as described herein.

According to another aspect, some embodiments include a non-transitory computer-readable medium storing a computer program product comprising instructions which, upon being executed by processing circuitry (e.g., at least one processor) of the wireless device, configure the processing circuitry to perform one or more functionalities of the wireless device as described herein.

According to a fourth aspect, some embodiments include a method in a network node for positioning. The method comprises: receiving a positioning request from a wireless device served by a New Radio (NR) network node, in a NR cell, for performing measurements based on Observed Time Difference of Arrival (OTDOA); determining whether timing information of the NR cell is available or not; in response to determining that the timing information of the NR cell is available, sending OTDOA assistance information based on the timing information of the NR cell to the wireless device.

According to a fifth aspect, some embodiments include a network node, such as a location server, for positioning. The network node is configured, or operable, to perform one or more functionalities (e.g. actions, operations, steps, etc.) of the network node as described herein.

In some embodiments, the network node may comprise one or more communication interfaces configured to communicate with one or more other radio nodes and/or with one or more network nodes, and processing circuitry operatively connected to the communication interface, the processing circuitry being configured to perform one or more functionalities of the network node as described herein. In some embodiments, the processing circuitry may comprise at least one processor and at least one memory storing instructions which, upon being executed by the processor, configure the at least one processor to perform one or more functionalities of the network node as described herein.

In some embodiments, the network node may comprise one or more functional modules configured to perform one or more functionalities of the network node as described herein.

According to another aspect, some embodiments include a non-transitory computer-readable medium storing a computer program product comprising instructions which, upon being executed by processing circuitry (e.g., at least one processor) of the network node, configure the processing circuitry to perform one or more functionalities of the network node as described herein.

Some embodiments may enable the following:
To solve the problem of not having SFN0 of the LTE cells for NR devices which require OTDOA positioning.
To reuse the SFTD measurement which is already defined for the purpose of creating a database in the location server on the timing information between LTE and NR cells.
To reduce the number of steps needed for the NR device to do OTDOA measurements and hence less signaling is required.

It is to be noted that any feature of any of the embodiments disclosed herein may be applied to any other embodiment, wherever appropriate. Likewise, any advantage of any of the embodiments may apply to the other embodiments, and vice versa. Certain embodiments may have some, or none of the above advantages. Other advantages will be apparent to persons of ordinary skill in the art. Other objectives, features and advantages of the enclosed embodiments will be apparent from the following description.

This summary is not an extensive overview of all contemplated embodiments, and is not intended to identify key or critical aspects or features of any or all embodiments or to delineate the scope of any or all embodiments. In that sense, other aspects and features will become apparent to those ordinarily skilled in the art upon review of the following description of specific embodiments in conjunction with the accompanying figures.

### BRIEF DESCRIPTION OF THE DRAWINGS

Exemplary embodiments will be described in more detail with reference to the following figures, in which:

FIG. 1 illustrates a schematic diagram of a NR architecture of positioning.

FIG. 2 is a flow chart of a method for sending SFTD measurements to a location server, in accordance with some embodiments.

FIG. 3 is a flow chart of a method for determining timing information between a NR radio network node and a LTE radio network node in accordance with some embodiments.

FIG. 4 is a flow chart of a method for performing positioning measurements, in accordance with some embodiments.

FIG. 5 is a flow chart of a method in a wireless device, in accordance with some embodiments.

FIG. 6 is a flow chart of another method in a wireless device, in accordance with some embodiments.

FIG. 7 is a flow chart of a method in a network node, in accordance with some embodiments.

FIGS. 8 and 9 illustrate a block diagram of a wireless device in accordance with some embodiments.

FIGS. 10-11 illustrate a block diagram of a network node in accordance with some embodiments.

FIG. 12 is a block diagram of a virtual environment for a network node and/or wireless device in accordance with some embodiments.

### DETAILED DESCRIPTION

The embodiments set forth below represent information to enable those skilled in the art to practice the embodiments. Upon reading the following description in light of the accompanying figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

As used herein, the singular forms “a”, “an” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

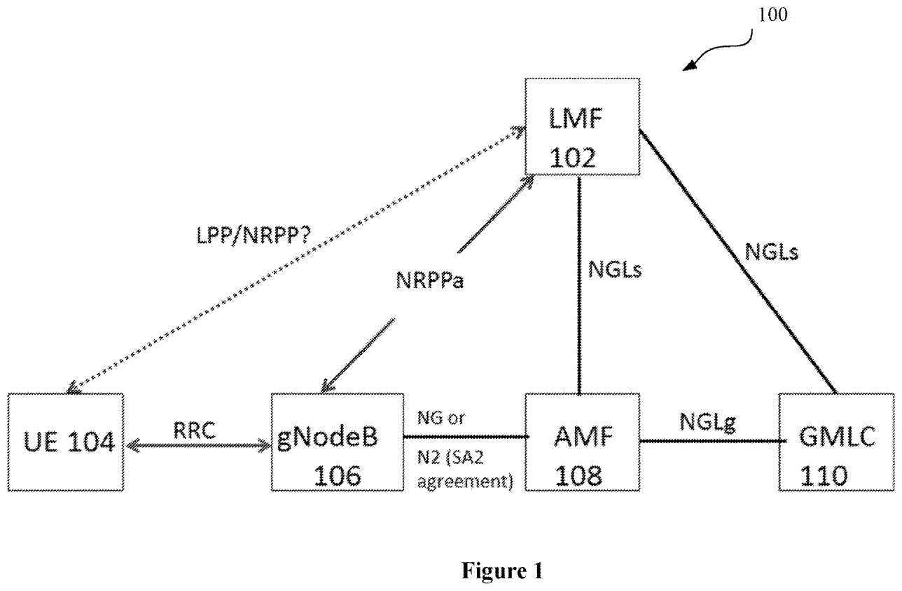

As presented earlier, FIG. 1 illustrates a NR architecture 100 for supporting positioning in NR. The architecture 100 comprises a location server 102, such as LMF, which is part of the core network, for example. The LMF or location server 102 can be connected to a plurality of network elements, such as a wireless device 104 (such as a UE), a radio network node 106 (such as gNodeB), an AMF 108 and a Gateway Mobile Location Centre (GMLC) 110.

The LMF 102 can communicate with the UE 104, using LPP or NRPP, for example. The LMF 102 can use the NRPPa protocol to communicate with the gNodeB 106. The LMF 102 can further use the NGLs to communicate with the AMF 108 and GMLC 110. It should be noted that communications between the network elements are possible. For example, the UE 104 can communicate with the gNodeB using RRC, the gNodeB can communicate with the AMF using Next Generation (NG) or N2 (in the S2 agreement) protocol/interface and the AMF 108 can communicate with the GMLC 110 using the NGLg protocol/interface.

There may be a plurality of UEs 104 within a coverage area of a serving cell, each of the UEs 104 may be capable of communicating directly with the radio network nodes 106, such as gNodeB, over a wireless interface. The radio network node 106 can be the serving network node of the UE or any network node with which the UE can establish or maintain a communication link and/or receive information (e.g. via broadcast channel). As such, the radio network node may comprise multiple antennas, distributed over a plurality of Remote Radio Heads (RRHs).

In certain embodiments, wireless devices or UEs 104 may also be capable of communicating with each other via device-to-device (D2D) communication. In certain embodiments, radio network nodes 106 may also be capable of communicating with each other, e.g. via an interface (e.g. X2 in LTE or other suitable interface).

As an example, wireless device 104 may communicate with radio network node 106 over a wireless interface. That is, wireless device 104 may transmit wireless signals and/or receive wireless signals from radio network node 106. The wireless signals may contain voice traffic, data traffic, control signals, and/or any other suitable information. In some embodiments, an area of wireless signal coverage associated with a radio network node 106 may be referred to as a cell.

In some embodiments wireless device 104 may be interchangeably referred to by the non-limiting term user equipment (UE). Wireless device 104 can be any type of wireless device capable of communications with a network node or another UE over radio signals. Examples of such UEs are a sensor, modem, smart phone, machine type (MTC) device aka machine to machine (M2M) device, Personal Digital Assistant (PDA), iPAD, Tablet, smart phone, laptop embedded equipped (LEE), laptop mounted equipment (LME), Universal Serial Bus (USB) dongles etc.

In some embodiments, the “radio network node” can be any kind of network nodes. Examples of network nodes are gNodeB, eNodeB, Node B, Base Station, wireless access point (AP), base station controller, radio network controller, relay, donor node controlling relay, base transceiver station (BTS), transmission points, transmission nodes, Remote Radio Unit (RRU), RRH, nodes in distributed antenna system (DAS), core network node, Mobility Management Entity (MME) etc.

In some embodiments, the radio network node 106 (such as gNodeB) may interface with a core network. The core network node may manage the establishment of communication sessions and various other functionalities for wireless devices 104. Examples of core network node 340 may include Mobile Switching Center (MSC), Mobility Management Entity (MME), Serving Gateway (SGW), Packet Gateway (PGW), Operation and Maintenance (O&M), Operating Support Systems (OSS), Self Organizing Network (SON), positioning node (e.g. E-SMLC), MDT node, etc. Wireless devices 104 may exchange certain signals with the core network node using the non-access stratum layer. In non-access stratum signaling, signals between wireless devices 104 and the core network node may be transparently passed through the radio access network. In certain embodiments, network nodes 106 may interface with one or more other network nodes over an internode interface. For example, network nodes 106 may interface each other over an X2 interface.

Although FIG. 1 illustrates a particular arrangement of network/architecture 100, the present disclosure contemplates that the various embodiments described herein may be applied to a variety of networks having any suitable configuration. For example, network/architecture 100 may include any suitable number of wireless devices 104 and radio network nodes 106, as well as any additional elements suitable to support communication between wireless devices or between a wireless device and another communication device (such as a landline telephone). The embodiments may be implemented in any appropriate type of telecommunication system supporting any suitable communication standards and using any suitable components and are applicable to any radio access technology (RAT) or multi-RAT systems in which the wireless device receives and/or transmits signals (e.g., data).

As mentioned before, the OTDOA method is based on the parameter SFN0 of the LTE serving cell. Embodiments of this disclosure intend to solve this problem so that the determination of the positioning of the NR devices 104 does not depend on the parameter SFN0 of the LTE serving cell when using the OTDOA method.

It should be noted that a NR device refers to a device or UE that is connected to a NR cell or that is served by a NR cell or base station, such as gNodeB 106. In a similar way, a LTE device is a device or UE that is connected to a LTE cell or is served by a LTE cell or base station such as an eNodeB. The embodiments of this disclosure provide support for the LTE OTDOA method for an NR device served by an NR radio network node, and not connected to a LTE cell (or LTE radio network node). In other words, the embodiments allow a NR device to measure the time of arrival of the PRS (Positioning Reference Signal) transmitted by LTE cells and to perform the OTDOA procedure similar to LTE devices.

For example, the embodiments can use the SFTD measurements already available in the LTE network. The latest approved definition of SFTD measurements given by 3GPP TS 36.214 (Release 15.1.0) is as follows:

| | |
|---|---|
| Definition | The observed SFN and frame timing difference (SFTD) between an E-UTRA PCell and an NR Cell is |
| | defined as comprising the following two components; |
| | SFN offset = (SFN_{PCell} − SFN_{NRCell}) mod 1024, where SFN_{PCell} is the SFN of a E-UTRA PCell radio |
| | frame and SFN_{NRCell} is the SFN of the NR Cell radio frame of which the UE receives the start closest |
| | in time to the time when it receives the start of the PCell radio frame. |
| | Frame boundary offset = └(T_{FrameBoundaryPCell} − T_{FrameBoundaryNRCell})/5┘, where |
| | T_{FrameBoundaryPCell} is the time when the UE receives the start of a radio frame from the PCell, |
| | T_{FrameBoundaryNRCell} is the time when the UE receives the start of the radio frame, from the NR Cell, |
| | that is closest in time to the radio frame received from the PCell. The unit of (T_{FrameBoundaryPCell} − |
| | T_{FrameBoundaryNRCell}) is Ts. |
| | UE shall compensate for the time difference between the moment it received the SSB of PCell and the |
| | moment it received the SSB of the to-be-measured NR Cell used for SFTD estimation. |
| Applicable for | RRC_CONNECTED intra-frequency, |
| | RRC_CONNECTED inter-RAT |

Collecting SFTD Measurement Information at the Location Server

The SFTD measurements provide the timing difference information between a LTE cell and a NR cell. Currently, a LTE device can report the SFTD measurements to the location server, such as LMF 102, but it is envisioned that in the future a NR device can also report such measurements to the location server. Therefore, the embodiments of this disclosure may include the latter alternative as well (i.e. the NR device reporting SFTD measurements to the location server).

The SFTD measurements are measured by the LTE UE, which then can send the SFTD measurements via RRC to the LTE cell serving the UE. Similar assumption can be made for the NR UE, i.e. in the future, this measurement can be done by a NR device and sent via NR RRC to the NR cell.

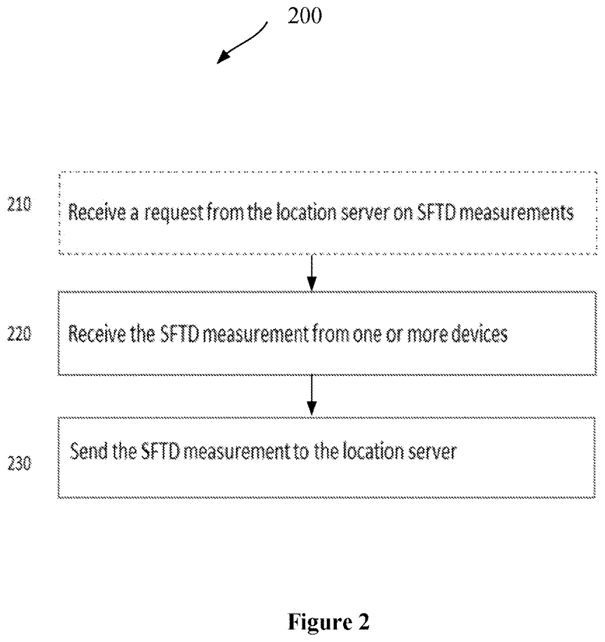

Now turning to FIG. 2, a flow chart of a method 200 of providing SFTD measurements to the location server, such as LMF 102, will be described. The method may be implemented in a radio network node, such as a gNodeB 106.

Method 200 may start with step 210, which is optional. For example, the location server may optionally send requests to one or more radio network nodes, such as gNodeB 106, to receive SFTD measurements. In the case of a NR radio network node, this would be signaled via NRPPa, and in the case of a LTE radio network node, this would be signaled via LPPa.

Upon receiving the requests, the one or more radio network nodes can in turn send requests to one or more devices to make the SFTD measurements.

In step 220, the one or more radio network nodes receive the SFTD measurements from the one or more devices, such as UEs 104.

In step 230, the one or more radio network nodes can either send each SFTD measurement from any UE separately to the location server or collect a set of those measurements and send them all in one signaling to the location server.

Once the location server receives all the SFTD measurements, the location server can build a database of the timing difference between all LTE and NR cells in a dual connectivity network or any other kinds of network, so that there is a mapping of timing difference between a LTE cell and a NR cell. In case there are some missing relations between LTE and NR cells, the location server can optionally request the radio network nodes serving in those LTE cells (or NR cells) to provide such measurements. The received SFTD measurements allow the location server to determine a timing relation (or difference) between the LTE and NR radio network nodes. There are different ways to express this timing relation, as will be appreciated by a person skilled in the art.

In case of LTE radio network nodes, the SFTD measurements are sent to the E-SMLC, which is the location server in the E-UTRA network. In case of NR radio network nodes, the SFTD measurements are sent to the LMF, which is the location server in the 5G core network. The LMF 102 receiving the SFTD measurements is not defined in the standard yet but the LMF can be easily enhanced to perform such actions. It has been already agreed that the information sharing between the E-SMLC and LMF can be considered based on their implementation. As a note, SFTD measurements are used in the embodiments for indicating a timing difference between NR cells and LTE cells. However, the embodiments are not limited to the SFTD measurements, they can comprise any information or parameter that can be used to indicate the timing difference between NR and LTE cells.

It should be noted that the database of the timing difference can be used in the OTDOA positioning procedure for a NR device, as explained below.

OTDOA Positioning Support for NR Devices

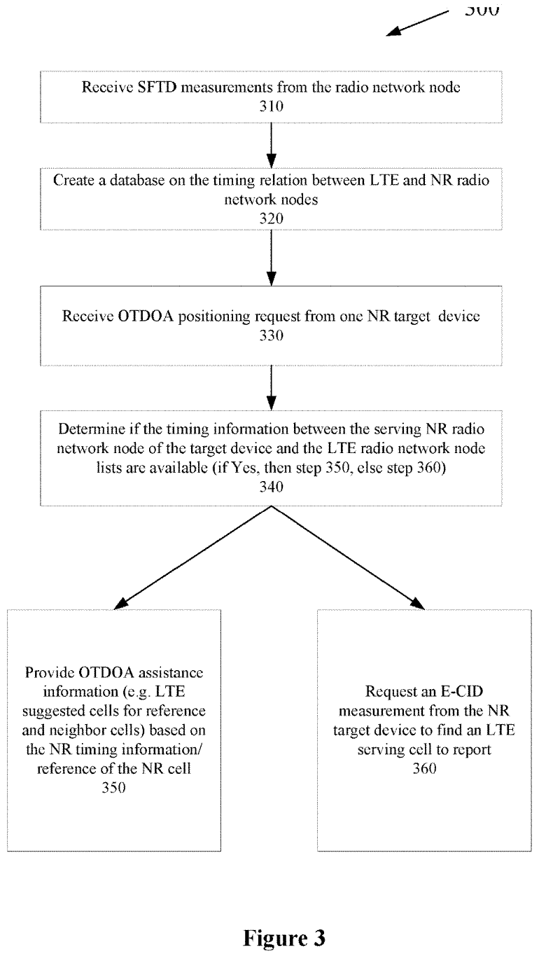

In FIG. 3, a flow chart of a method 300 for assisting OTDOA measurements is illustrated. The method can be implemented in a location server, such as LMF 102, for example.

Method 300 starts with step 310, in which the location server can receive SFTD measurements from one or more radio network nodes, which corresponds to step 230 of method 200.

In step 320, the location server can create a database of timing difference or timing relation between LTE and NR radio network nodes.

In step 330, the location server may receive an OTDOA positioning request from one NR target device. As a note, the device is called a target device because the device is targeted for positioning. The terms “NR target device” or “NR device” or “device” can be interchangeably used.

When the location server (or LMF) receives the positioning request for the NR device, either from the AMF or from the device directly, the location server can request for the device positioning capabilities. In case the NR device has the LTE OTDOA capability, then the device can request for OTDOA assistance information from the location server. This signaling can be done in LPP even for NR devices.

The OTDOA assistance information includes for example the PRS configuration of a reference cell and a list of neighbor cells to be suggested for OTDOA measurements by the device. In legacy systems, the timing information of PRS configurations is based on the SFN0 of a LTE cell. However, now with the embodiments of this disclosure, the location server has a timing relation information between the LTE and NR cells (through the SFTD measurements). As such, the location server can determine a timing information or timing reference of a NR cell.

In step 340, upon receiving the OTDOA positioning request, the location server determines whether there is a timing information available for the serving NR cell of the NR target device or not. In other words, the location server determines if there is a mapping in its database of timing difference information between the serving NR cell and a LTE cell (or LTE radio network node).

If the answer is positive, in step 350, the location server provides the OTDOA assistance information based on timing information of the NR cell to the NR device. This timing information is available and deduced from the reported SFTD measurements of a plurality of devices, for example. The OTDOA assistance information may comprise suggested LTE cells and neigbhour cells in which to measure reference signals.

In one embodiment, the location server may send the OTDOA assistance information to the NR device based on the timing information of the NR cell as the reference timing information. In another embodiment, the location server may send the OTDOA assistance information based on the LTE reference timing information as legacy with an additional delta timing information which corresponds to the difference between the reference timing of the LTE and NR cells.

If the answer is negative following step 340, it means that the location server is not able to provide OTDOA assistance information to the NR target device, as there is no timing information available. Therefore, the location server sends a timing information request to the NR target device in step 360, so that the NR target device can find an LTE cell from which the NR device can measure the PRS and report the measurement to the location server. Before doing the PRS measurement, the NR device needs to find the timing information (such as SFN0) of the LTE cell. The timing request can be a timing and a cell information request. The timing and cell information request may comprise an E-CID measurement request, for example.

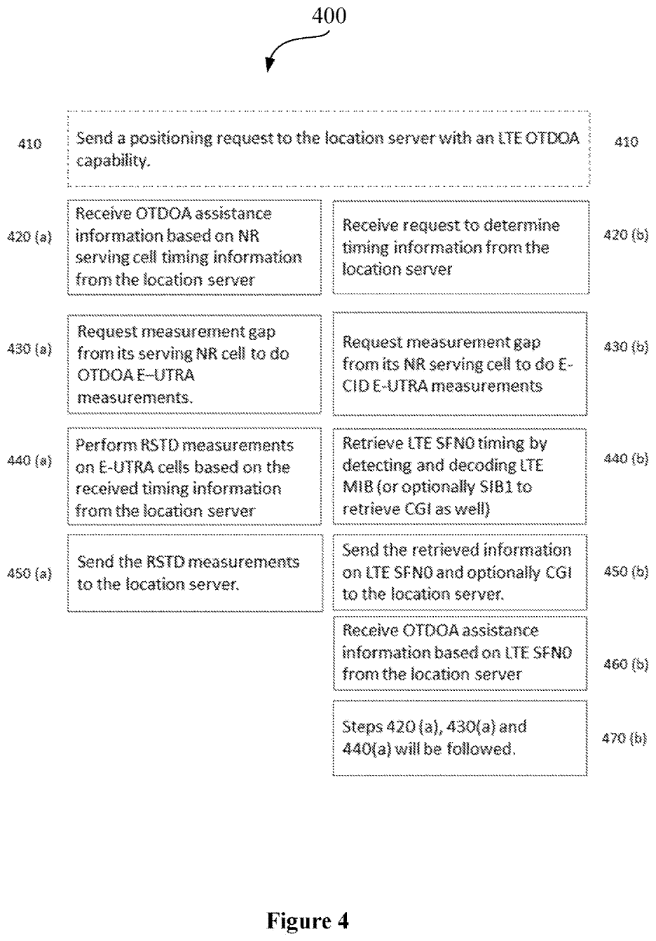

Now turning to FIG. 4, a flow chart of a method 400 for performing positioning measurements will be described. The positioning measurements are for example OTDOA positioning measurements. The method can be implemented in a NR device, such as a UE 104. Furthermore, the NR device is connected to (or served by) a NR cell, as such, it has no access to LTE cells' information. Also, the NR device may be surrounded by LTE cells.

Method 400 starts with step 410, in which the NR device sends a positioning request to the location server, e.g. LMF 102. In one embodiment, the positioning request to the location server may be triggered by some other network node such as AMF 108, or a radio network node such as gNodeB 106. In other words, the AMF 108 or the gNodeB 106 can send the positioning request to the location server. In any ways, the target device should have the LTE OTDOA capability.

Upon receiving the positioning request, the location server may check if the timing information of the NR serving cell of the target device is available at the location server. The timing information can be determined based on the SFTD measurements. If the location server determines that the timing information of the NR serving cell is available, then the location server sends some OTDAO assistance information to the NR target device. The timing information can comprise a timing reference of the NR cell, for example.

Therefore, in step 420(a), the NR device receives the OTDOA assistance information based on the NR serving cell timing information from the location server. The OTDOA assistance information may comprise the PRS configuration of a reference cell and a list of neighbor cells to be suggested for OTDOA measurements.

In order to perform OTDOA positioning/procedure, the NR target device needs to perform Reference Signal Time difference (RSTD) measurements based on the PRS transmitted by the LTE cells. Before the NR target device can perform the RSTD measurements, it needs a permission to perform measurements on the LTE cells, since the NR device is connected to a NR cell. As such, the NR device sends an inter-RAT measurement gap request to its serving NR cell in step 430(a) as the request for permission to perform measurements on LTE cells. This signaling can be done on the RRC level. Upon receipt of the measurement gap request, the NR cell can provide a suitable inter-RAT measurement gap to the target device for the OTDOA measurements.

After receiving the measurement gap, the NR target device can start performing RSTD measurements on a number of LTE cells in which it can estimate the time of arrival of the reference signals, in step 440(a). It should be noted that both the reference cell and neighbor cells are LTE cells, but the received OTDOA assistance timing information is based on the NR serving cell of the NR target device.

In step 450(a), the NR target device sends to the location server the RSTD measurements so that the location server can perform the multi-lateration techniques on the received RSTD measurements and derive the NR target device position estimation (this is referred to as network-based positioning). In some further steps, the location server can share the estimated positioning coordinates with the NR target device. In case of UE-based positioning, the target NR device may also receive the network coordinate information and derive the position estimation by itself. The network coordinate information may comprise location coordinate information of a set of reference and neighbor cells in the network for use in the multi-lateration.

In step 410, if the location server determines that the timing information of the NR serving cell of the NR target device is not available at the location server, then the NR target device may receive a request to retrieve timing information in step 420(b). For example, the request to retrieve timing information may include performing an E-CID measurement to find a LTE cell at the E-UTRA network (LTE network) on which the NR device can measure the positioning reference signals. The request to retrieve timing information may comprise a request to retrieve timing and cell information as the NR device needs to identify a cell and retrieve the SFN0 information.

In order for the NR target device to perform the E-CID measurement, the NR target device needs to require an inter-RAT measurement gap from its NR serving cell (in step 430(b)), since the NR device needs to do these measurements on the LTE cells. This signaling can be done on the RRC level. After receipt of the inter-RAT measurement gap request, the NR cell can provide a suitable inter-RAT measurement gap to the target device for the E-CID measurement.

After receiving the measurement gap, the NR target device can start detecting and decoding LTE Master Information Block (MIB) to retrieve the timing information (such as SFN0) of a LTE cell, in step 440(b). Optionally the target device may detect the System Information Block (SIB1) messages to retrieve the Cell Global ID (CGI).

In step 450(b), the NR target device sends the retrieved LTE timing information (SFN0) to the location server in order to receive proper OTDOA assistance information.

Upon receipt of the LTE timing information, the location server provides the NR target device with the OTDOA assistance information based on the timing information (e.g. SFN0) of the LTE serving cell, in step 460(b).

After receiving the OTDOA assistance information from the location server, the NR target device can perform the steps that are similar to steps 430(a), 440(a) and 450(a).

In some embodiments, step 420(b) may be skipped. If the timing information is not available in the server location, the NR device may request for the inter-RAT measurement gap, as in step 430(b) but without the E-CID measurement request from the location Server.

In another embodiment, that location server can also build a timing relation database by obtaining the measurement values directly from the eNB or gNB. In this case, the eNB and gNB may share the timing relation across the interface X2 or Xn. Then, the location server may retrieve the measurement information via LPPa or NPPa.

Even though the embodiments have been described for particular networks, such as NR and LTE, it will be appreciated by a person skilled in the art that the embodiments described herein may be applicable to other networks as well, such as a first network that is different from a second network.

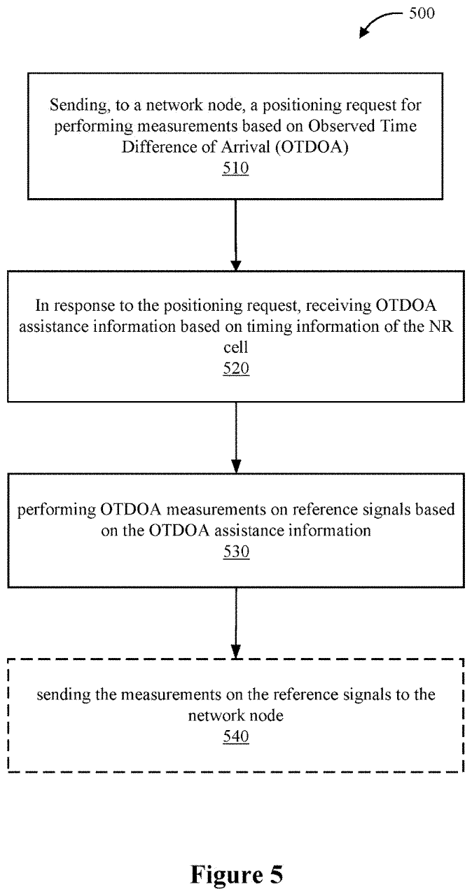

FIG. 5 illustrates a method 500 in a wireless device 104, according to one embodiment taught herein, wherein method 500 is based in part on method 400. The wireless device is served by a network node in a first type of network, for example, a NR network node, in a NR cell. A second type of network could be the LTE network, comprising LTE cells.

Method 500 comprises:

Step 510: Sending, to a network node, a positioning request for performing measurements based on Observed Time Difference of Arrival (OTDOA). The network node may be a location server, such as LMF 104, for example.

Step 520: In response to the positioning request, receiving OTDOA assistance information based on timing information of the NR cell.

Step 530: Performing OTDOA measurements on reference signals based on the OTDOA assistance information.

Step 540 (optionally): Sending the measurements on the reference signals to the network node.

In some embodiments, the timing information of the NR cell can be derived from System frame number and Frame Timing Difference (SFTD) measurements between Long Term Evolution (LTE) cells and NR cells.

In some embodiments, the timing information of the NR cell can be based on a timing difference between NR cells and LTE cells. For example, the timing difference between the NR cells and LTE cells is determined based on SFTD measurements.

In some embodiments, the received OTDOA assistance information can comprise a Positioning Reference Signal (PRS) of a reference cell and a list of neighbor cells to be used in the OTDOA measurements. For example, the reference cell and the list of neighbor cells are Long Term Evolution (LTE) cells.

In some embodiments, the method 500 can further comprise sending a request for a measurement gap to the NR network node in the NR cell to perform the OTDOA measurements in the LTE cells.

In some embodiments, performing the OTDOA measurements on the reference signals based on the OTDOA assistance information can be based on performing Reference Signal Time Difference (RSTD) measurements based on the timing information of the NR cell.

In some embodiments, the wireless device has capabilities to perform OTDOA measurements on LTE cells.

In some embodiments, receiving the OTDOA assistance information based on timing information of the NR can be based on timing information of LTE reference timing information with a delta timing information which corresponds to a difference between a reference timing of LTE and NR cells.

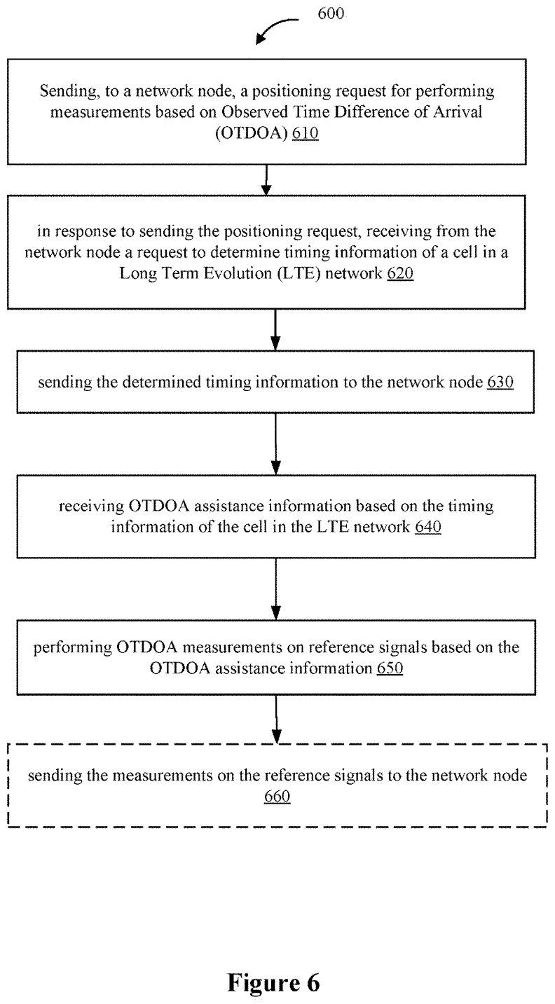

FIG. 6 illustrates a method 600 in a wireless device 104, according to one embodiment taught herein, wherein method 600 is based in part on method 400. The wireless device is served by a NR network node, in a NR cell, for example. The NR network can be considered to be a first type of network and the LTE network can be considered to be a second type of network.

Method 600 comprises:

Step 610: Sending, to a network node, a positioning request for performing measurements based on Observed Time Difference of Arrival (OTDOA). The network node may be a location server, such as LMF 102, for example.

Step 620: In response to sending the positioning request, receiving from the network node a request to determine timing information of a cell in a Long Term Evolution (LTE) network. In this case, the network node does not have timing information between NR cells and LTE cells. As such, the network node determines the timing information of the LTE cell from the wireless device.

Step 630: Sending determined timing information of the cell in the LTE network to the network node.

Step 640: Receiving OTDOA assistance information based on the timing information of the cell in the LTE network. For example, based on the determined timing information, the network node can now determine the OTDOA assistance information.

Step 650: Performing OTDOA measurements on reference signals based on the OTDOA assistance information.

Step 660 (Optional): Sending the measurements on the reference signals to the network node.

In some embodiments, the method 600 may comprise determining the timing information of the cell in the LTE network by performing an Enhanced-Cell IDentity (E-CID) measurement.

In some embodiments, the method may further send a request for a measurement gap for performing the E-CID measurement. For example, performing the E-CID measurement may comprise retrieving the timing information of the cell in the LTE network from an information block.

In some embodiments, the timing information may be a System Frame Number 0 (SNF0).

In some embodiments, performing the OTDOA measurements on reference signals based on the OTDOA assistance information may be comprise performing Reference Signal Time Difference (RSTD) measurements based on the timing information of the cell.

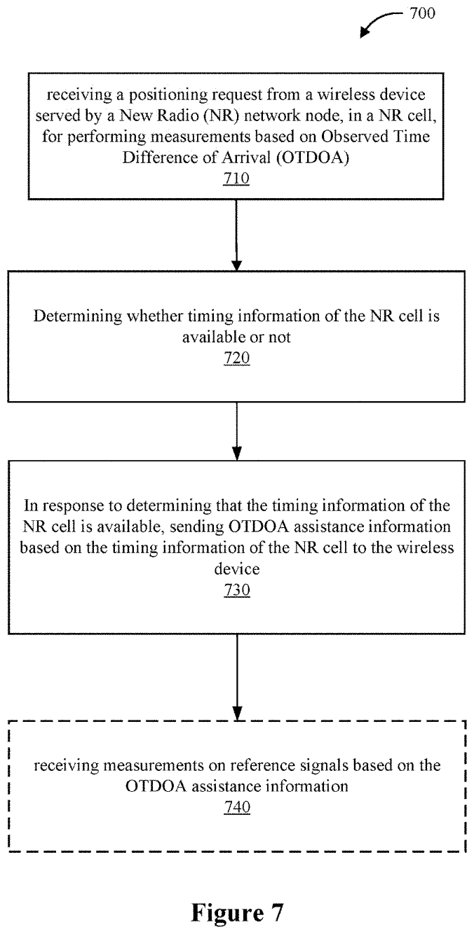

FIG. 7 illustrates a method in a network node, such as a location server 102, according to one embodiment taught herein, wherein method 700 is based in part on method 300. As a note, this method involves two types of networks, e.g., the NR network can be considered to be a first type of network and the LTE network can be considered to be a second type of network.

Method 700 comprises:

Step 710: Receiving a positioning request from a wireless device served by a NR network node in a NR cell, for performing measurements based on Observed Time Difference of Arrival (OTDOA).

Step 720: Determining whether timing information of the NR cell is available or not.

Step 730: In response to determining that the timing information of the NR cell is available, sending OTDOA assistance information based on the timing information of the NR cell to the wireless device.

Step 740 (Optional): Receiving measurements on reference signals based on the OTDOA assistance information.

For example, the timing information of the NR cell can be given through a database of corresponding timing information between NR cells and LTE cells. The corresponding timing information between NR and LTE cells can be provided through the SFTD measurements. As such, the timing information of the NR cell is based on a timing difference between NR cells and LTE cells.

In some embodiments, the method 700 can create such a database of timing difference between NR cells and LTE cells based on SFTD measurements.

In some embodiments, the method 700 may further receive the SFTD measurements from the wireless device or another network node.

In some embodiments, the SFTD measurements in a database are collected from one wireless device and can be applied to some other wireless devices.

In some embodiments, the received measurements on the reference signals can be Reference Signal Time Difference (RSTD) measurements based on the timing information of the NR cell.

In some embodiments, the received OTDOA assistance information based on timing information of the NR cell can be based on timing information of LTE reference timing information with a delta timing information which corresponds to a difference between a reference timing of LTE and NR cells.

In some embodiments, in response to determining that timing information of the NR cell is not available, the method 700 may further send a request to the wireless device to determine timing information of a cell in a Long Term Evolution (LTE) network, receive the determined timing information of the cell and send OTDOA assistance information based on the timing information of the cell in the LTE network.

In some embodiments, the request to determine the timing information may comprise a request to perform an Enhanced-Cell ID (E-CID) measurement. In this case, the method 700 may receive a request for a measurement gap for performing the E-CID measurement.

In some embodiments, the OTDOA assistance information may comprise a Positioning Reference Signal (PRS) of a reference cell and a list of neighbor cells for OTDOA measurement, which can be all Long Term Evolution (LTE) cells, for example.

In some embodiments, the method 700 may further send a request for device positioning capabilities of the wireless device.

In another embodiment, a method in a wireless device (e.g. 104) served by a network node in a first type of network (such as a NR network node, in a NR cell) is provided. The method comprises:
sending, to a network node (e.g. a location server), a positioning request for performing measurements based on Observed Time Difference of Arrival (OTDOA);
in response to the request, receiving OTDOA assistance information based on timing information of a cell in the first type of network node (such as the NR cell); and
performing OTDOA measurements on reference signals based on the received OTDOA assistance information.

It should be noted that the OTDOA procedure is used in a second type of network, such as a LTE network.

In yet another embodiment, a method in a wireless device (e.g. 104) served by a network node in a first type of network (such as a NR network node, in a NR cell) is provided. The method comprises:
sending, to a network nod (e.g. location server) e, a positioning request for performing measurements based on Observed Time Difference of Arrival (OTDOA);
in response to sending the positioning request, receiving from the network node a request to determine timing information of a cell in a second network (such as a LTE network);
sending determined timing information of the cell in the second network, to the network node;
receiving OTDOA assistance information based on the determined timing information of the cell in the second network; and
performing OTDOA measurements on reference signals based on the OTDOA assistance information.

It is understood that in some embodiments, the blocks of the flowcharts above may occur out of the order noted in the figures. For example, two blocks shown in succession may, in fact, be executed substantially concurrently, or the blocks may sometimes be executed in the reverse order, depending upon the functionality involved.

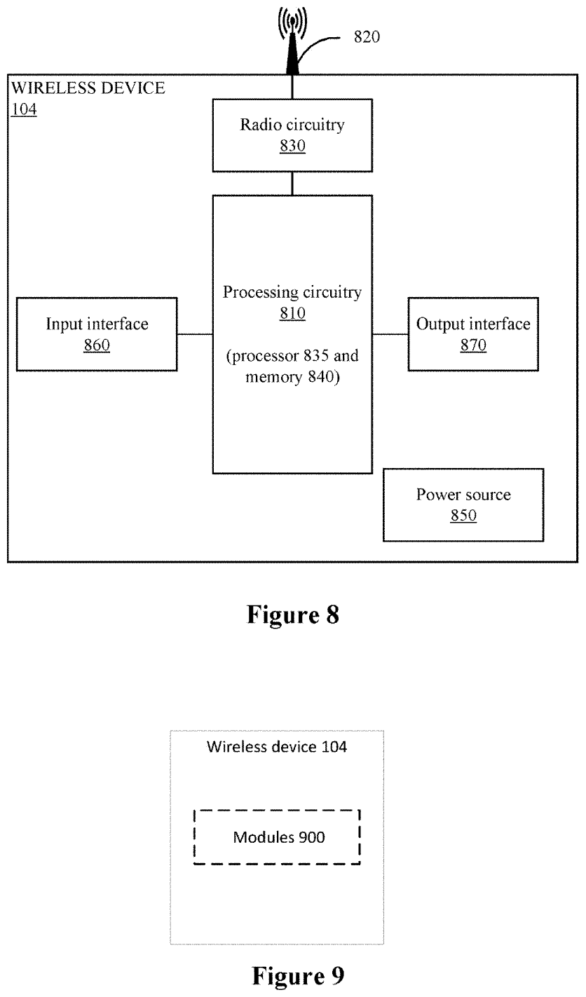

Some embodiments of a wireless device 104 will now be described with respect to FIGS. 8 and 810. Even though the expression wireless device is used throughout the description, it is to be understood that the expression is used generically. In that sense, a wireless device (WD) generally refers to a device capable, configured, arranged and/or operable to communicate wirelessly with one or more network nodes (e.g., radio network nodes) and/or with one or more other wireless devices. Notably, different communication standards may use different terminology when referring or describing wireless device. For instance, 3GPP uses the terms User Equipment (UE) and Mobile Terminal (MT). For its part, 3GPP2 uses the terms Access Terminal (AT) and Mobile Station (MS). And IEEE 802.11 (also known as WiFi™) uses the term station (STA).

In some embodiments, a wireless device may be configured to transmit and/or receive information without direct human interaction. Such a wireless device may be referred to as a Machine Type Communication (MTC) device or as a Machine-to-Machine (M2M) device.

FIG. 8 is a block diagram of an exemplary wireless device 104 in accordance with some embodiments. Wireless device 104 includes one or more of a transceiver (such as antennas 820), processor, and memory. In some embodiments, the transceiver facilitates transmitting wireless signals to and receiving wireless signals from radio network node 106 (e.g., via transmitter(s) (Tx), receiver(s) (Rx) and antenna(s)). The processor executes instructions to provide some or all of the functionalities described above as being provided by wireless device 104, and the memory stores the instructions executed by the processor. In some embodiments, the processor 835 and the memory 840 form processing circuitry (810).

The processor 835 may include any suitable combination of hardware to execute instructions and manipulate data to perform some or all of the described functions of wireless device 104, such as the functions of wireless device 104 described above, for example methods 400, 500 and 600. In some embodiments, the processor may include, for example, one or more computers, one or more central processing units (CPUs), one or more microprocessors, one or more application specific integrated circuits (ASICs), one or more field programmable gate arrays (FPGAs) and/or other logic.

The memory 840 is generally operable to store instructions, such as a computer program, software, an application including one or more of logic, rules, algorithms, code, tables, etc. and/or other instructions capable of being executed by a processor. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information, data, and/or instructions that may be used by the processor of wireless device 104.

Other embodiments of wireless device 104 may include additional components beyond those shown in FIG. 8 that may be responsible for providing certain aspects of the UE's functionalities, including any of the functionalities described above and/or any additional functionalities (including any functionality necessary to support the solution described above). As just one example, wireless device 104 may include input devices and circuits, output devices, and one or more synchronization units or circuits, which may be part of the processor. Input devices include mechanisms for entry of data into wireless device 104. For example, input devices may include input mechanisms, such as a microphone, input elements, a display, etc. Output devices may include mechanisms for outputting data in audio, video and/or hard copy format. For example, output devices may include a speaker, a display, etc.

FIG. 9 is a block diagram of another exemplary wireless device 104 in accordance with some embodiments. As illustrated, in some embodiments, the wireless device 104 may comprise a series of modules (or units) 900 configured to implement some or all of the functionalities of the wireless device 104 described above. More particularly, in some embodiments, the wireless device 104 may comprise a sending module, a receiving module, and a performing module. The sending module is configured to perform step 510 and 540 of method 500 and/or step 610, 630 and 660 of method 600. The receiving module is configured to perform step 520 of method 500 and/or steps 620 and 640 of method 600. The performing module is configured to perform step 530 of method 500 and/or step 650 of method 600.

It will be appreciated that the various modules may be implemented as combination of hardware and/or software, for instance, the processor, memory and transceiver(s) of wireless device 104 shown in FIG. 8. Some embodiments may also include additional modules to support additional and/or optional functionalities.

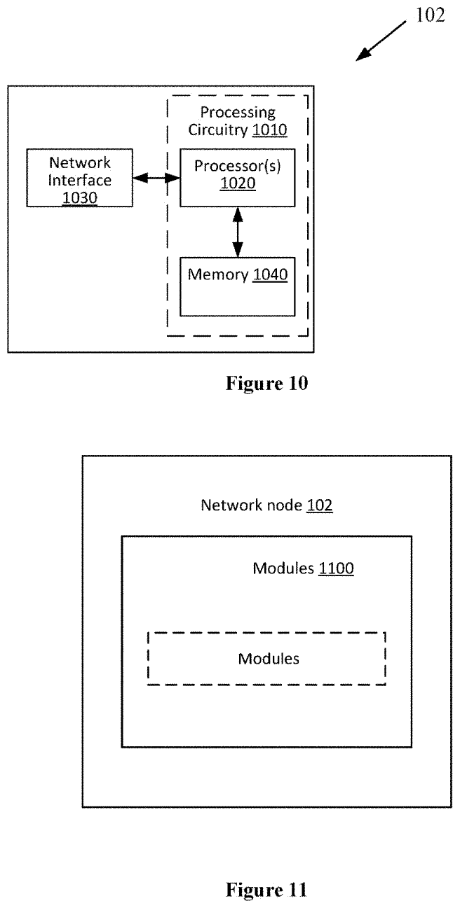

Embodiments of a network node such as a location server 102 will now be described with respect to FIGS. 10 to 11.

FIG. 10 is a block diagram of an exemplary network node 102, in accordance with certain embodiments. network node 102 may include one or more processor 1020, memory 1040, and network interface 1030. The processor 1020 executes instructions to provide some or all of the functionalities described above as being provided by a network node 102, the memory stores the instructions executed by the processor. In some embodiments, the processor and the memory form processing circuitry 1010. The network interface 1030 communicates signals to network components, such as a gateway, switch, router, Internet, Public Switched Telephone Network (PSTN), other core network nodes or radio network controllers, base stations, etc.

The processor 1020 may include any suitable combination of hardware to execute instructions and manipulate data to perform some or all of the described functions of network node 102, such as those described above, for example methods 300 and 700. In some embodiments, the processor may include, for example, one or more computers, one or more central processing units (CPUs), one or more microprocessors, one or more application specific integrated circuits (ASICs), one or more field programmable gate arrays (FPGAs) and/or other logic.

The memory 1040 is generally operable to store instructions, such as a computer program, software, an application including one or more of logic, rules, algorithms, code, tables, etc. and/or other instructions capable of being executed by a processor. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, the network interface is communicatively coupled to the processor and may refer to any suitable device operable to receive input for network node 102, send output from network node 102, perform suitable processing of the input or output or both, communicate to other devices, or any combination of the preceding. The network interface may include appropriate hardware (e.g., port, modem, network interface card, etc.) and software, including protocol conversion and data processing capabilities, to communicate through a network.

Other embodiments of radio network node 102 may include additional components beyond those shown in FIG. 10 that may be responsible for providing certain aspects of the radio network node's functionalities, including any of the functionalities described above and/or any additional functionalities (including any functionality necessary to support the solutions described above). The various different types of network nodes may include components having the same physical hardware but configured (e.g., via programming) to support different radio access technologies, or may represent partly or entirely different physical components.

In some embodiments, the network node 102 may comprise a series of modules 1100 configured to implement the functionalities of the network node 102 described above. Referring to FIG. 11, in some embodiments, the network node 102 may comprise a receiving module, a sending module and a determining module. The receiving module is configured to perform steps 710 and 740 (optional) of method 700. The sending module is configured to perform step 730 of method 700. The determining module is configured to perform step 720 of method 700, for example.

It will be appreciated that the various modules may be implemented as combination of hardware and/or software, for instance, the processor, memory and transceiver(s) of network node 102 shown in FIG. 10. Some embodiments may also include additional modules to support additional and/or optional functionalities.

Embodiments may also be practiced in distributed computing environments where tasks are performed by remote-processing devices that are linked through a communications network.

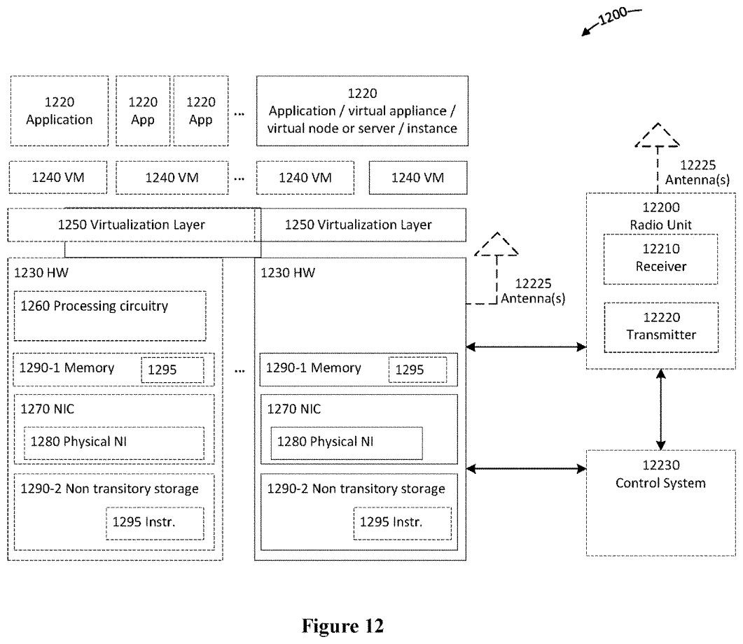

For example, FIG. 12 is a schematic block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to a network node 102 (e.g., a virtualized location server) or to a device 104 (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1200 hosted by one or more of hardware nodes 1230. Further, in embodiments in which the virtual node is not a radio access node or does not require radio connectivity (e.g., a core network node), then the network node may be entirely virtualized.

The functions may be implemented by one or more applications 1220 (which may alternatively be called software instances, virtual appliances, network functions, virtual nodes, virtual network functions, etc.) operative to implement some of the features, functions, and/or benefits of some of the embodiments disclosed herein. Applications 1220 are run in virtualization environment 1200 which provides hardware 1230 comprising processing circuitry 1260 and memory 1290. Memory 1290 contains instructions 1295 executable by processing circuitry 1260 whereby application 1220 is operative to provide one or more of the features, benefits, and/or functions disclosed herein.

Virtualization environment 1200, comprises general-purpose or special-purpose network hardware devices 1230 comprising a set of one or more processors or processing circuitry 1260, which may be commercial off-the-shelf (COTS) processors, dedicated Application Specific Integrated Circuits (ASICs), or any other type of processing circuitry including digital or analog hardware components or special purpose processors. Each hardware device may comprise memory 1290-1 which may be non-persistent memory for temporarily storing instructions 1295 or software executed by processing circuitry 1260. Each hardware device may comprise one or more network interface controllers (NICs) 1270, also known as network interface cards, which include physical network interface 1280. Each hardware device may also include non-transitory, persistent, machine-readable storage media 1290-2 having stored therein software 1295 and/or instructions executable by processing circuitry 1260. Software 1295 may include any type of software including software for instantiating one or more virtualization layers 1250 (also referred to as hypervisors), software to execute virtual machines 1240 as well as software allowing it to execute functions, features and/or benefits described in relation with some embodiments described herein.

Virtual machines 1240, comprise virtual processing, virtual memory, virtual networking or interface and virtual storage, and may be run by a corresponding virtualization layer 1250 or hypervisor. Different embodiments of the instance of virtual appliance 1220 may be implemented on one or more of virtual machines 1240, and the implementations may be made in different ways.

During operation, processing circuitry 1260 executes software 1295 to instantiate the hypervisor or virtualization layer 1250, which may sometimes be referred to as a virtual machine monitor (VMM). Virtualization layer 1250 may present a virtual operating platform that appears like networking hardware to virtual machine 1240.

As shown in FIG. 13, hardware 1230 may be a standalone network node with generic or specific components. Hardware 1230 may comprise antenna 12225 and may implement some functions via virtualization. Alternatively, hardware 1230 may be part of a larger cluster of hardware (e.g. such as in a data center or customer premise equipment (CPE)) where many hardware nodes work together and are managed via management and orchestration (MANO), which, among others, oversees lifecycle management of applications 1220.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1240 may be a software implementation of a physical machine that runs programs as if they were executing on a physical, non-virtualized machine. Each of virtual machines 1240, and that part of hardware 1230 that executes that virtual machine, be it hardware dedicated to that virtual machine and/or hardware shared by that virtual machine with others of the virtual machines 1240, forms a separate virtual network elements (VNE).

Still in the context of NFV, Virtual Network Function (VNF) is responsible for handling specific network functions that run in one or more virtual machines 1240 on top of hardware networking infrastructure 1230 and corresponds to application 1220 in FIG. 12.

In some embodiments, one or more radio units 12200 that each include one or more transmitters 12220 and one or more receivers 12210 may be coupled to one or more antennas 12225. Radio units 12200 may communicate directly with hardware nodes 1230 via one or more appropriate network interfaces and may be used in combination with the virtual components to provide a virtual node with radio capabilities, such as a radio access node or a base station.

In some embodiments, some signalling can be effected with the use of control system 12230 which may alternatively be used for communication between the hardware nodes 1230 and radio units 12200.

Some embodiments may be represented as a non-transitory software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to one or more of the described embodiments. Those of ordinary skill in the art will appreciate that other instructions and operations necessary to implement the described embodiments may also be stored on the machine-readable medium. Software running from the machine-readable medium may interface with circuitry to perform the described tasks.

The above-described embodiments are intended to be examples only. Alterations, modifications and variations may be effected to the particular embodiments by those of skill in the art without departing from the scope of the description.

1-36. (canceled)

37. A wireless device for performing positioning measurements comprising a processor and a memory, the memory containing instructions executable by the processor, whereby the wireless device is operative to:
send, to a network node, a positioning request for performing measurements based on Observed Time Difference of Arrival (OTDOA);
in response to the positioning request, receive OTDOA assistance information based on timing information of the NR cell; and
perform OTDOA measurements on reference signals based on the received OTDOA assistance information.

38. The wireless device of 37, wherein the processor is configured to send the OTDOA measurements on the reference signals to the network node.

39. The wireless device of claim 37, wherein the timing information of the NR cell is derived from System frame number and Frame Timing Difference (SFTD) measurements between Long Term Evolution (LTE) cells and NR cells.

40. The wireless device of claim 37, wherein the timing information of the NR cell is based on a timing difference between NR cells and LTE cells.

41. The wireless device of claim 40, wherein the timing difference between the NR cells and LTE cells is determined based on SFTD measurements.

42. The wireless device of claim 37, wherein the received OTDOA assistance information comprises a Positioning Reference Signal (PRS) of a reference cell and a list of neighbor cells to be used in the OTDOA measurements.

43. The wireless device of claim 42, wherein the reference cell and the list of neighbor cells are Long Term Evolution (LTE) cells.

44. The wireless device of claim 37, wherein the processor is further configured to send a request for a measurement gap to the NR network node in the NR cell to perform the OTDOA measurements in the LTE cells.

45. The wireless device of claim 44, wherein the processor is configured to perform the OTDOA measurements on the reference signals based on the OTDOA assistance information by performing Reference Signal Time Difference (RSTD) measurements based on the timing information of the NR cell.

46. The wireless device of claim 37, wherein the network node is a location server.

47. The wireless device of claim 37, wherein the wireless device is configured with capabilities to perform OTDOA measurements on LTE cells.

48. The wireless device of claim 37, wherein the processor is configured to receive the OTDOA assistance information based on timing information of the NR by receiving the OTDOA assistance information based on timing information of LTE reference timing information with a delta timing information which corresponds to a difference between a reference timing of LTE and NR cells.

49. A wireless device comprising:
a communication interface;
one or more processing circuits communicatively connected to the communication interface, and configured to:
send, to a network node, a positioning request for performing measurements based on Observed Time Difference of Arrival (OTDOA);
in response to sending the positioning request, receive from the network node a request to determine timing information of a cell in a Long Term Evolution (LTE) network;
send determined timing information of the cell in the LTE network, to the network node;
receive OTDOA assistance information based on the determined timing information of the cell in the LTE network; and
perform OTDOA measurements on reference signals based on the OTDOA assistance information; and
a power supply to supply power to the wireless device.

50. The wireless device of claim 49, wherein the processor is configured to send the measurements on the reference signals to the network node.

51. The wireless device of claim 49, wherein the processor is configured to determine the timing information by performing an Enhanced-Cell IDentity (E-CID) measurement.

52. The wireless device of claim 51, wherein the processor is configured to send a request for a measurement gap for performing the E-CID measurement.

53. The wireless device of claim 51, wherein the processor is configured to perform the E-CID measurement by retrieving the timing information of the cell in the LTE network from an information block.

54. The wireless device of claim 49, wherein the timing information is a System Frame Number 0 (SNF0).

55. The wireless device of claim 49, wherein the processor is configured perform the OTDOA measurements on reference signals based on the OTDOA assistance information by performing Reference Signal Time Difference (RSTD) measurements based on the timing information of the cell.

56. (canceled)

57. (canceled)

58. (canceled)

59. A network node for determining positioning of a wireless device comprising a processor and a memory, the memory containing instructions executable by the processor, whereby the wireless device is operative to:
receive a positioning request from a wireless device served by a New Radio (NR) cell, for performing measurements based on Observed Time Difference of Arrival (OTDOA);
determine whether timing information of the NR cell is available or not;
in response to determining that the timing information of the NR cell is available, send OTDOA assistance information based on the timing information of the NR cell to the wireless device.

60-74. (canceled)
